(19) United States
(12) Patent Application Publication
(10) Pub. No.: US 2005/0151414 A1
(43) Pub. Date: Jul. 14, 2005

(54) Wheel cap and retainer assembly

(76) Inventor: Gregory R. Hauler, Montague, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/757,311

(22) Filed: Jan. 14, 2004

(51) Int. Cl. B60B 27/00

(52) U.S. Cl. 301/108.4

(57) ABSTRACT

A wheel cover assembly comprises a wheel cover that includes a body portion having an outer surface and an inner surface opposed across the body portion from the outer surface, and at least one elongated tubularly-shaped extension having a proximal portion connected to the body portion, and a distal portion extending in a direction away from the inner surface of the body portion. The wheel cover assembly also includes at least one connector member having a proximal end snappably coupled with the distal end of the extension of the wheel cover, and a distal end adapted to releasably couple with a vehicle wheel.

### BACKGROUND OF THE INVENTION

The present invention relates to a wheel cover assembly, and in particular to a retainer assembly for releasably coupling a wheel cap or cover with a vehicle wheel.

Ornamental outer coverings have been employed for providing a decorative surface to the exposed surface of a vehicle wheel for many years. These outer coverings offer design flexibility and various configurations that may be used to cover a single style wheel. In certain applications, the ornamental wheel covering is constructed of a polymeric material or plastic that is then coated with a metal plating. U.S. Pat. Nos. 5,564,791; 5,577,809; 5,597,213; 5,630,654; 5,636,906; 5,845,973; and 6,085,829, the disclosures of which are incorporated herein by reference, represent different approaches for providing and attaching such claddings to existing wheels to provide a decorative appearing wheel.

Heretofore, wheel coverings have been assembled with the associated vehicle wheel by a variety of clips and/or fasteners having a configuration such that the cover member or wheel clad is in direct contact with at least a portion of the vehicle wheel, and/or a configuration wherein a significant amount of heat generated within the vehicle wheel, due to braking and the like, is transferred from the fastener to the attached wheel cladding. The heat received by the wheel may result in heat fatigue, thereby reducing the useful life of the wheel clad, as well as distortion and degradation to the aesthetic outer covering associated therewith. Moreover, previous wheel coverings and associated clips and/or fasteners have been configured to allow mating or coupling with only a single configuration of the vehicle wheel. This static sort of design for the vehicle wheels adds to the associated manufacturing costs across a line of vehicles, in that individual wheel coverings and associated clips and fasteners must be manufactured for each wheel of varying configuration.

Therefore, there is a current need for a connecting apparatus that insulates the wheel cover or cladding from heat being transferred between the vehicle wheel and the wheel cladding, while simultaneously providing a secure connection between the vehicle wheel and the wheel cover. Further, there is a current need for a connecting apparatus that is dynamic in configuration, so as to allow the wheel cover or cladding to be utilized with a variety of vehicle wheel configurations without requiring a complete redesign of the wheel cover.

### SUMMARY OF THE INVENTION

One aspect of the present invention is to provide a wheel cover assembly that comprises a wheel cover including a body portion having an outer surface and an inner surface opposed across the body portion from the outer surface, and at least one elongated tubularly-shaped extension having a proximal portion connected to the body portion, and a distal portion extending in a direction away from the inner surface of the body portion. The wheel cover assembly also includes at least one connector member having a proximal end snappably coupled with the distal end of the extension of the wheel cover, and a distal end adapted to releasably couple with a vehicle wheel.

Another aspect of the present invention is to provide a wheel cover assembly that comprises a wheel cover including a body portion having an outer surface and an inner surface opposed across the body portion from the outer surface, and at least one extension having a proximal portion connected to the body portion, a distal portion extending in a direction away from the inner surface of the body portion, and an end wall. The wheel cover assembly also includes at least one connector member having an outer surface, an inner surface having at least one irregularity spaced along a length therefore, and a proximal end coupled with the at least one extension of the wheel cover such that the at least one connector member abuts the end wall of the at least one extension, wherein the irregularity is adapted to engage a vehicle wheel, thereby coupling the wheel cover with the vehicle wheel, and wherein the at least one extension does not support the outer surface of the at least one connector member.

Yet another aspect of the present invention is to provide a wheel cover assembly that comprises a wheel cover including a body portion having an outer surface and an inner surface opposed across the body portion from the outer surface, and at least extension having a proximal portion connected to the body portion, a distal portion extending in a direction away from the inner surface of the body portion, and an inner wall. The wheel cover assembly also includes at least one connector member including a proximal portion adapted to snappably couple with the at least one extension, and a distal portion adapted to snappably couple with a vehicle wheel.

The present inventive wheel cover assembly provides a more durable and heat resistant wheel covering that may be operated/installed by even unskilled personnel, can be easily and quickly assembled, is economical to manufacture, capable of a long operating life while installed on the associated vehicle wheel, is dynamically adaptable to varying wheel configurations and is particularly well adapted for the proposed use.

These and other advantages of the present invention will be further understood and appreciated by those skilled in the art by reference to the following written specification, claims and appended drawings.

### BRIEF DESCRIPTION OF THE DRAWINGS

FIG. 1 is a perspective view of a wheel assembly;

FIG. 2 is an exploded perspective view of the wheel assembly that includes a retaining assembly and a wheel cap or cover embodying the present invention;

FIG. 3 is a perspective view of wheel cover assembly;

FIG. 4 is an exploded perspective view of a portion of a connector member and an extension of the cover member of the wheel cover assembly;

FIG. 5 is a cross-sectional side view of the portion of the connector member and the extension as illustrated in FIG. 4;

FIG. 6 is a cross-sectional side view of the portion of the connector member and the extension as illustrated in FIG. 4, wherein the portion of the connector member is coupled with the extension, and the wheel cover assembly is coupled with a vehicle wheel;

FIG. 7 is an exploded perspective view of a first alternative embodiment of the connector member and extension;

FIG. 8 is a cross-sectional side view of the first alternative embodiment of the connector member and extension as assembled with the vehicle wheel;

FIG. 9 is an exploded perspective view of a second alternative embodiment of the connector member and extension;

FIG. 10 is a cross-sectional side view of the second alternative embodiment of the connector member and extension as assembled with the vehicle wheel;

FIG. 11 is an exploded perspective view of a third alternative embodiment of the connector member and extension; and

FIG. 12 is a cross-sectional side view of the third alternative embodiment of the connector member and extension as assembled with the vehicle wheel.

### DETAILED DESCRIPTION OF THE PREFERRED EMBODIMENTS

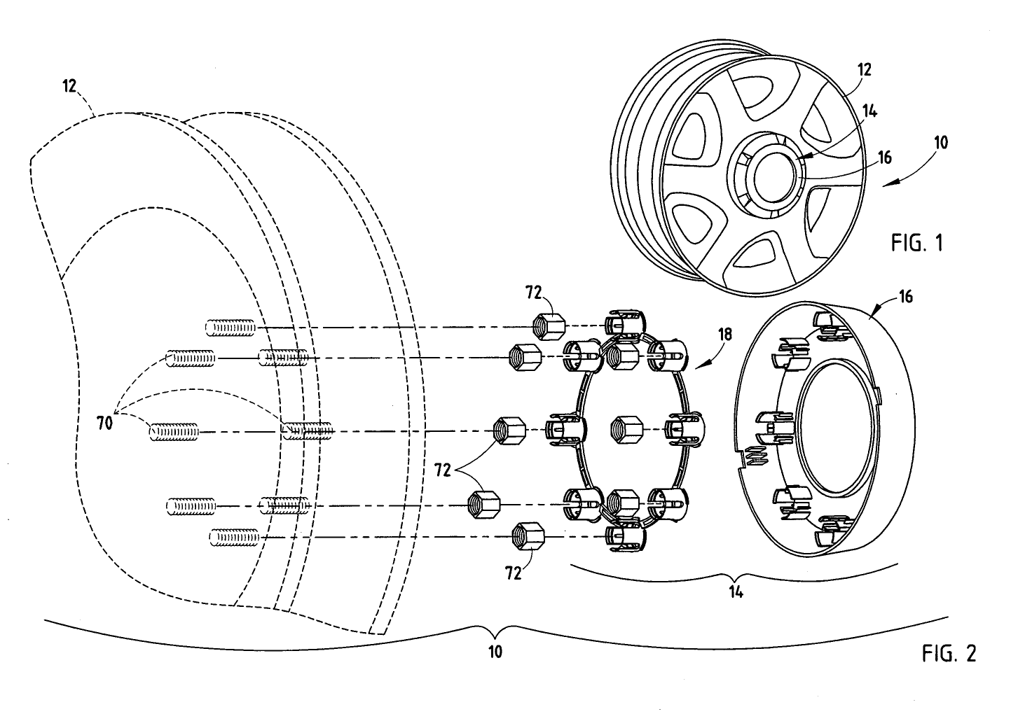

For purposes of description herein, the terms “upper,” “lower,” “right,” “left” “rear,” “front,” “vertical,” “horizontal,” and derivatives thereof shall relate to the invention as oriented in FIGS. 1 and 2. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

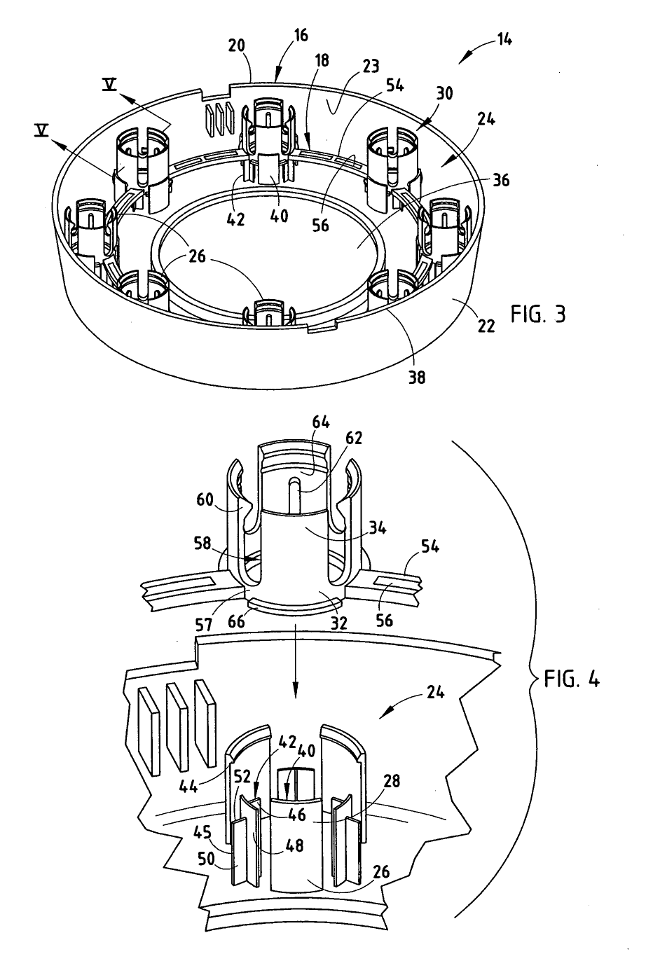

The reference numeral 10 (FIGS. 1 and 2) generally designates a wheel assembly that includes a vehicle wheel 12 and a wheel cover or clad assembly 14. The wheel cover assembly 14 includes a cover or body portion 16 and a locking ring 18. The cover member 16 (FIGS. 3 and 4) includes a body portion 20 having an outer surface 22 and an inner surface 23 opposed across the body portion 20 from the outer surface 22. The cover member 16 further includes a plurality of tubularly-shaped extensions 24 each having a proximal portion 26 connected to the body portion 20, and a distal portion 28 extending in a direction away from the inner surface 23 of the body portion 20. The locking ring 18 includes a plurality of connector members 30 each having a proximal end 32 snappingly coupled with the distal portion 28 of the extensions 24 of the cover member 16, and a distal end 34 adapted to releasably couple with the vehicle wheel 12. The cover member 16 and the locking ring 18 of the wheel cover assembly 14 are preferably constructed of different materials, however, similar materials may be used for the construction of each of these components. Specifically, the cover member 16 is typically constructed of a lower cost material that is better suited for receiving a metal plating aesthetic outer covering, while the locking ring 18 is preferably constructed of a more highly heat-resistant material.

The body portion 20 of the cover member 16 is bowl-shaped having an end wall 36 and an inwardly-turned sidewall 38. The plurality of extensions or locking arrangements 24 are spaced circumferentially about and extend inwardly from the inner surface 23 of the end wall 36 and are integrally molded therewith. Each extension 24 includes a plurality of flexibly resilient locking fingers 40 and a plurality of alignment fingers 42. Each locking finger 40 is provided with an inwardly-extending tab 44 located at the distal end 28 thereof. Each alignment finger 42 includes four cross ribs 45, including an inner rib 46, a pair of arcuately-shaped side ribs 48, and an outer rib 50. In the illustrated example, the inner rib 46 and the side ribs 48 extend further from the inner surface 23 than outer rib 50, thereby providing outer rib 50 with an end support wall 52.

The connector members 30 of the locking ring 18 are interspaced by and integrally formed with a plurality of arcuately-shaped structural members or runners 54 that cooperate with the connector members 30 to provide the locking ring 18 with a substantially ring-shape. Each structural member 54 includes apertures 56 that extend therethrough, thereby reducing the material required in the construction thereof. Each connector member 30 is substantially tubularly-shaped and includes a body portion 57 and a plurality of flexibly resilient fingers 58 extending from the body portion 57. Each finger 58 includes a tab 60 located at the distal end 34 thereof, and a tab 62 extending inwardly from an inner surface 64 of each finger 58. A plurality of locking tabs 66 or lips extend circumferentially about the body portion 57 and are spaced circumferentially about the body portion 57 so as to align with the locking fingers 40 of the cover member 16, as described below.

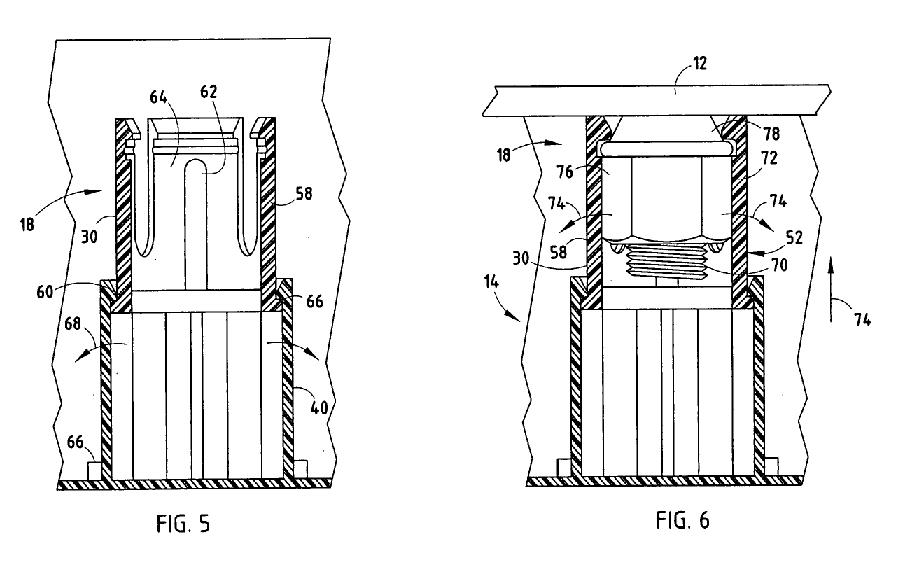

In assembly, the locking ring 18 is aligned with the cover member 16 such that each connector member 30 is aligned with the extensions 24 of the cover member 16. However, it should be noted that it is not required that each and every connector member 30 axially align with a corresponding extension 24, as locking rings of varying configurations may be provided in order to couple the cover member 16 with wheels 12 of various configurations. In the illustrated example, the locking ring 18 (FIG. 5) and the cover member 16 are pressed together so as to cause the locking fingers 40 of each extension 24 to flex outwardly in a direction as indicated by directional arrows 68 as the locking tab 60 of each finger 58 rides over the tabs 66, thereby securing the locking ring 18 with the cover member 16. It should be noted that during assembly, the locking fingers 40 and the alignment fingers 42 of each extension 24 are oriented such that the locking fingers 40 are located outside of the corresponding connector member 30 and abut the outer surface thereof, while the alignment fingers 42 are located within the interior of the corresponding connector member 30, such that the side ribs 38 abut the inner surface of the associated connector member 30. Once assembled, an underside of the connector member 30 is supported by the end support wall 52 of each alignment finger 42, and is held in position by the tab 44 of each locking finger 40.

The wheel cover assembly 14 (FIG. 6) is assembled with the vehicle wheel 12 by aligning the connector members 30 with the lug bolts 70 and lug nuts 72 as associated with the wheel 12. The wheel cover assembly 14 is then pressed inwardly in a direction 74 towards the wheel 12, thereby causing the fingers 58 of each connector member 30 to flex outwardly in a direction as indicated by directional arrows 74 as the expanded head portion 76 of each lug nut 72 is received between the fingers 58, until the tab 60 of each finger 58 abuts a shoulder 78 of each lug nut 72, thereby securing the wheel cover assembly 14 with the vehicle wheel 12.

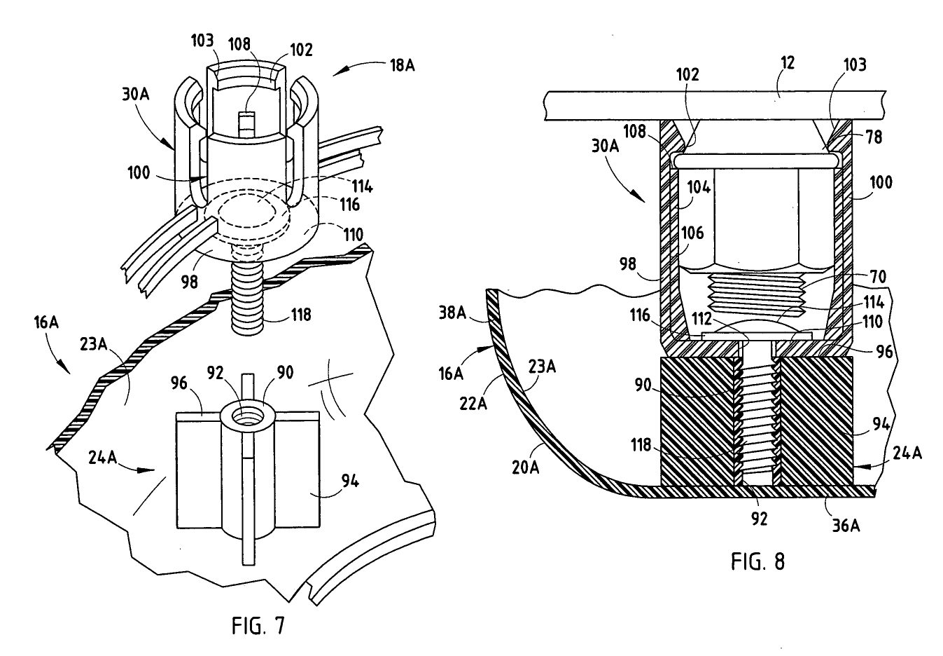

The reference numeral 10A (FIG. 7) generally designates another embodiment of the present invention, having a cover member 16A and a connector member 30A. Since the cover member 16A and the connector member 30A are similar to the cover member 16 and the connector member 30, similar parts appearing in FIGS. 5 and 6 and FIGS. 7 and 8 are respectively represented by the same, corresponding reference numeral, except for the suffix “A” appearing in the numerals of the latter. The extensions 24A each include a tubularly-shaped body portion 90 having a circular cross-sectional geometrical configuration and define a central aperture 92 therein. Each extension 24A also includes a plurality of structural support ribs 94 extending outwardly from and along the length of the body portion 90. The body portion 90 and ribs 94 of each extension 24A are integrally molded with the body portion 20A and cooperate to form an end wall 96.

Each connector member 30A includes a body portion 98 and a plurality of longitudinally-extending flexibly-resilient fingers 100 extending outwardly from the body portion 98. Each finger 100 includes an inwardly-extending locking tab 102 and an alignment wall 104 extending inwardly from an inner surface 106 and having a stop wall 108 located at an end thereof. Each connector member 30A further includes an end wall 110 having a centrally-located aperture 112 extending therethrough.

In assembly, each connector member 30A is coupled with a corresponding extension 24A by aligning the aperture 112 of the connector member 30A with the aperture 92 of the extension 24A and threadably inserting a mechanical-type fastener, such as screw 114 through aperture 112 and into aperture 92, such that the end wall 110 of the connector member 30A is held in abutment with the end wall 96 of the corresponding extension 24A. Preferably, the screw 14 includes an enlarged rounded washer head 116, and a tri-lobular thread that cooperates to prevent loosening of the screw 114 and minimizing hoop stress as exerted on the end wall 110 of the connector member 30A. It should be noted that other means of attachment may be utilized, including orbital spin, heat staking, sonic staking, and the like.

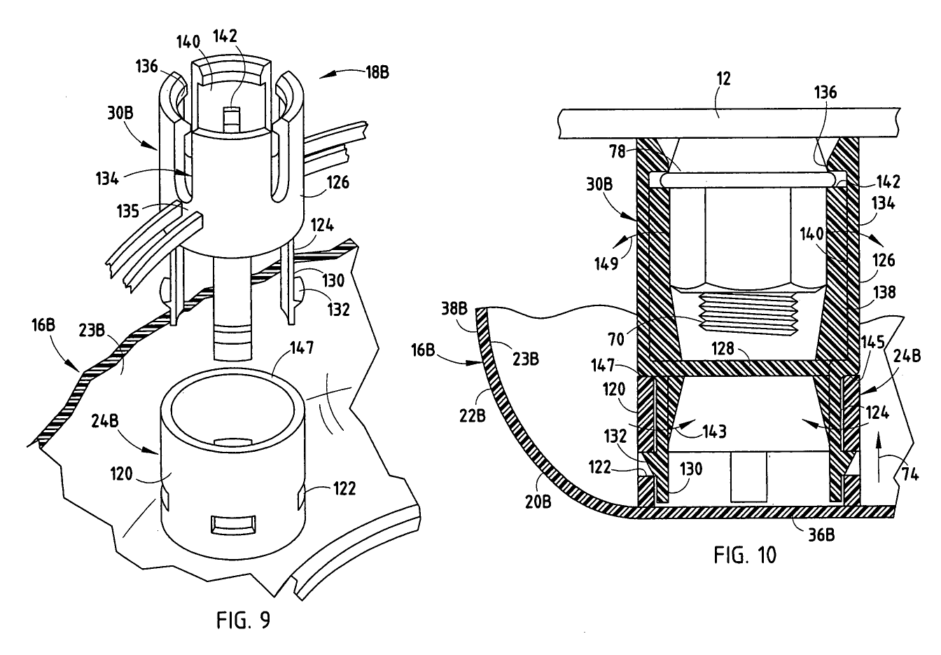

The reference numeral 10B (FIGS. 9 and 10) generally designates yet another embodiment of the present invention having a cover member 16B and a connector member 30B. Since the cover member 16B and the connector member 30B are similar to the previously described cover member 16 and connector member 30, similar parts appearing in FIGS. 5 and 6 and FIGS. 9 and 10, respectively are represented by the same, corresponding reference numeral, except for the suffix “B” in the numerals of the latter. Each extension 24B includes a tubularly-shaped body portion 120 having a plurality of locking apertures 122 spaced circumferentially thereabout. Each extension 24B is preferably integrally molded with the body portion 20B of the cover member 16B. Each connector member 30B includes a proximal end 124 and a distal end 126 that are divided by a wall 128. The proximal end 124 of the connector member 30B includes a plurality of longitudinally-extending flexibly resilient fingers 130 each having an outwardly extending locking tab 132. The distal end 126 of each connector member 30B includes a plurality of longitudinally-extending flexibly resilient fingers 134 extending outwardly from a cylindrically-shaped body portion 135, each having a locking tab 136 located at a distal end thereof, and an alignment wall 138 extending inwardly from an inner surface 140 of the corresponding finger 134. Each alignment wall 138 defines a stop wall 142 at an end thereof.

In assembly, each connector member 30B is aligned with the extensions 24B of the cover member 16B. In the illustrated example, the locking ring 18B and the cover member 16B are pressed together so as to cause the locking fingers 130 of each connector member 30B to flex inwardly in a direction as indicated by directional arrows 143 as the locking tab 132 of each finger 130 rides with the body portion 120 of the associated extension 24B, until the locking tabs 132 are received within the apertures 122, thereby securing the locking ring 18B with the cover member 16B. Once assembled, an underside 145 of the connector member 30B is supported by an end support wall 147 of the associated extension 24B.

As best illustrated in FIG. 10, the wheel cover assembly 14B is assembled with the vehicle wheel 12 by aligning the connector members 30B with the lug bolts 70 and lug nuts 72 as associated with the wheel 12. The wheel cover assembly 14B is then pressed inwardly in a direction 74 towards the wheel 12, thereby causing the fingers 134 of each connector member 30B to flex outwardly in a direction as indicated by directional arrows 149 as the expanded head portion 76 of each lug nut 72 is received between the fingers 134, until the tab 136 of each finger 34 abuts a shoulder 78 of each lug nut 72, thereby securing the wheel cover assembly 14B with the vehicle wheel 12.

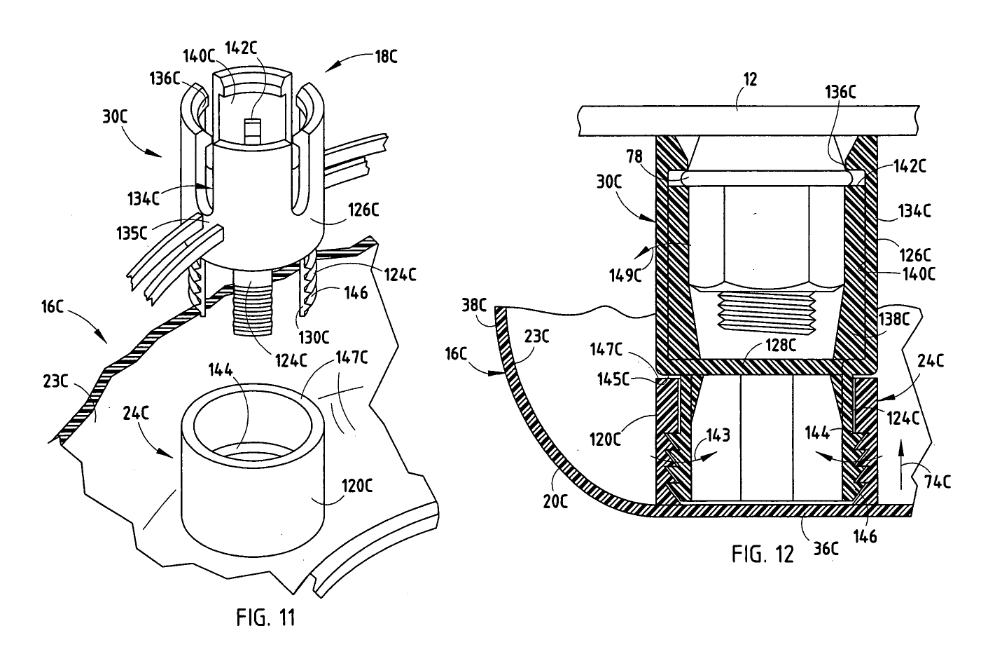

The reference numeral 10C (FIGS. 11 and 12) generally designates still yet another embodiment of the present invention having a cover member 16C and a plurality of connector members 30C. Since the wheel assembly 10E is similar to the previously described wheel assembly 10A, similar parts appearing in FIGS. 7 and 8 and FIGS. 11 and 12, respectively are represented by the same, corresponding reference numeral, except for the suffix “C” in the numerals of the latter. Each extension 24C includes a tubularly-shaped body portion 120C having a plurality of inwardly-extending locking grooves 144 spaced circumferentially thereabout. Each extension 24C is preferably integrally molded with the body portion 20C of the cover member 16C. Each connector member 30C includes a proximal end 124C and a distal end 126C that are divided by a wall 128C. The proximal end 124C of each connector member 30C includes a plurality of longitudinally-extending flexibly resilient fingers 130C each having a plurality of outwardly extending locking tabs 146. The distal end 126 of each connector member 30C includes a plurality of longitudinally-extending flexibly resilient fingers 134C extending outwardly from a body portion 135C and each having a locking tab 136C located at a distal end thereof, and an alignment wall 138C extending inwardly from an inner surface 140C. Each alignment wall 138 defines a stop wall 142C at an end thereof.

In assembly, the locking ring 18C is aligned with the cover member 16C such that each connector member 30C is aligned with the extensions 24C of the cover member 16C. In the illustrated example, the locking ring 18C and the cover member 16C are pressed together so as to cause the locking fingers 130C of each connector member 30C to flex inwardly in a direction as indicated by directional arrows 143C as the locking tab 146 of each finger 130C ride within the body portion 120C of the associated extension 24C, until the locking tabs 146 are mateably received by the locking groove 144, thereby securing the locking ring 18C with the cover member 16C. Once assembled, an underside 145C of the connector member 30C is supported by an end support wall 147C of the associated extension 24B.

As best illustrated in FIG. 12, the wheel cover assembly 14C is assembled with the vehicle wheel 12 by aligning the connector members 30C with the lug bolts 70 and lug nuts 72 as associated with the wheel 12. The wheel cover assembly 14C is then pressed inwardly in a direction 74 towards the wheel 12, thereby causing the fingers 134C of each connector member 30C to flex outwardly in a direction as indicated by directional arrow 149C as the expanded head portion 76 of each lug nut 72 is received between the fingers 134C, until the tab 136C of each finger 134C abuts a shoulder 78 of each lug nut 72, thereby securing the wheel cover assembly 14C with the vehicle wheel 12.

The present inventive wheel cover assembly provides a more durable and heat resistant wheel covering that may be operated/installed by even unskilled personnel, can be easily and quickly assembled, is economical to manufacture, capable of a long operating life while installed on the associated vehicle wheel, is dynamically adaptable to varying wheel configurations and is particularly well adapted for the proposed use.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A wheel cover assembly, comprising:
a wheel cover including a body portion having an outer surface and an inner surface opposed across the body portion from the outer surface, and at least one elongated tubularly-shaped extension having a proximal portion connected to the body portion, and a distal portion extending in a direction away from the inner surface of the body portion; and
at least one connector member having a proximal end snappably coupled with the distal end of the extension of the wheel cover, and a distal end adapted to releasably couple with a vehicle wheel.

2. The wheel cover assembly of claim 1, wherein the extension of the wheel cover comprises a first material and the connector member comprises a second material that is different from the first material.

3. The wheel cover assembly of claim 1, wherein the at least one extension includes a plurality of extensions circumferentially spaced about the wheel cover.

4. The wheel cover assembly of claim 3, wherein the at least one connector member includes a plurality of connector members, and wherein the plurality of connector members are connected to one another via a plurality of structural members.

5. The wheel cover assembly of claim 4, wherein the connector members and the structural members cooperate to form a ring-shape.

6. The wheel cover assembly of claim 5, wherein the connector members are axially aligned with the extensions of the cover member.

7. The wheel cover assembly of claim 5, wherein the connector members and the structural members are integrally formed.

8. The wheel cover assembly of claim 1, wherein the distal portion of the at least one extension includes an irregularity spaced along a length thereof.

9. The wheel cover assembly of claim 1, wherein the at least one extension includes a plurality of longitudinally extending fingers.

10. The wheel cover assembly of claim 9, wherein each of the fingers of the at least one extension includes a tab member spaced along a length thereof.

11. The wheel cover assembly of claim 10, wherein the at least one connector member includes a lip that cooperates with the tab of the at least one extension to snappably couple the at least one connector member to the wheel cover.

12. The wheel cover assembly of claim 10, wherein the at least one connector member includes a plurality of support legs interspaced with the plurality of fingers, and wherein the support legs support the at least one connector member thereon.

13. The wheel cover assembly of claim 12, wherein the at least one connector member includes an inner surface and an outer surface, and wherein the plurality of fingers are adapted to abut the outer surface of the at least one connector member, and the plurality of legs are adapted to abut the inner surface of the at least one connector member.

14. The wheel cover assembly of claim 1, wherein the at least one connector member includes a plurality of longitudinally extending flexibly resilient fingers, and wherein each finger includes a tab spaced along a length thereof adapted to releasably engage a lug nut associated with the vehicle wheel.

15. The wheel cover assembly of claim 1, wherein the at least one extension is integrally formed with the wheel cover.

16. The wheel cover assembly of claim 1, wherein the at least one extension has a substantially circular cross-sectional geometry.

17. A wheel cover assembly, comprising:
a wheel cover including a body portion having an outer surface and an inner surface opposed across the body portion from the outer surface, and at least one extension having a proximal portion connected to the body portion, a distal portion extending in a direction away from the inner surface of the body portion, and an end wall; and
at least one connector member having an outer surface, an inner surface having at least one irregularity spaced along a length thereof, and a proximal end coupled with the distal end of the at least one extension of the wheel cover such that the at least one connector member abuts the end wall of the at least one extension, wherein the irregularity is adapted to engage a vehicle wheel, thereby coupling the wheel cover with the vehicle wheel, and wherein the at least one extension does not support the outer surface of the at least one connector member.

18. The wheel cover assembly of claim 17, wherein the at least one connector member includes a plurality of longitudinally extending flexibly resilient fingers.

19. The wheel cover assembly of claim 18, wherein the at least one irregularity includes a tab extending inwardly from each finger, and wherein each tab is adapted to engage a lug nut associated with the vehicle wheel.

20. The wheel cover assembly of claim 19, wherein each finger includes an inwardly extending support wall adapted to abut the lug nut associated with vehicle wheel, and wherein the support walls cooperate with the tabs of the fingers to prevent axially shifting of the wheel cover when coupled to the vehicle wheel.

21. The wheel cover assembly of claim 20, wherein the at least one extension includes a tubularly-shaped body portion having a centrally located longitudinally extending aperture.

22. The wheel cover assembly of claim 21, wherein the at least one extension includes at least one support wall extending radically outward from the body portion.

23. The wheel cover assembly of claim 22, wherein the body portion and the at least one support wall are integrally formed with the wheel cover.

24. The wheel cover assembly of claim 23, wherein the at least one connector member includes an end wall having a mounting aperture extending therethrough, and wherein the at least one connector member is coupled with the at least one extension by a mechanical-type fastener extending through the mounting aperture of the at least one connector member and received within the body portion of the at least one extension.

25. The wheel cover assembly of claim 17, wherein the at least one extension includes a tubularly-shaped body portion having a centrally located longitudinally extending aperture.

26. The wheel cover assembly of claim 25, wherein the at least one extension includes at least one support wall extending radially outward from the body portion.

27. The wheel cover assembly of claim 26, wherein the body portion and the at least one support wall are integrally formed with the wheel cover.

28. The wheel cover assembly of claim 17, wherein the at least one connector member is coupled with the at least one extension by a mechanical-type fastener.

29. The wheel cover assembly of claim 17, wherein the at least one extension includes a plurality of extension members circumferentially spaced about the cover member.

30. The wheel cover assembly of claim 17, wherein the at least one extension comprises a first material, and wherein the at least one connector member comprises a second material that is different than the first material.

31. The wheel cover assembly of claim 17, wherein the at least one connector member includes a plurality of connector members, and wherein the plurality of connector members are connected to one another via a plurality of structural members.

32. The wheel cover assembly of claim 31, wherein the connector members and the structural members cooperate to form a ring-shape.

33. A wheel cover assembly, comprising:
a wheel cover including a body portion having an outer surface and an inner surface opposed across the body portion from the outer surface, and at least one extension having a proximal portion connected to the body portion, a distal portion extending in a direction away from the inner surface of the body portion, and an end wall; and
at least one connector member including a proximal portion adapted to snappably couple with the at least one extension, and a distal portion adapted to snappably couple with a vehicle wheel.

34. The wheel cover assembly of claim 33, wherein the distal portion includes a plurality of longitudinally extending flexibly resilient fingers.

35. The wheel cover assembly of claim 34, wherein each of the fingers includes a tab member located along a length thereof and adapted to engage a lug nut of the vehicle wheel.

36. The wheel cover assembly of claim 35, wherein each finger includes an inwardly extending support wall adapted to abut the lug nut associated with vehicle wheel, and wherein the support walls cooperate with the tabs of the fingers to prevent axially shifting of the wheel cover when coupled to the vehicle wheel.

37. The wheel cover assembly of claim 36, wherein the at least one connector member includes an end wall located between the distal portion and the proximal portion thereof.

38. The wheel cover assembly of claim 37, wherein the proximal portion of the at least one connector member includes a plurality of longitudinally extending flexibly resilient fingers.

39. The wheel cover assembly of claim 38, wherein each of the fingers of the proximal portion of the at least one connector member includes at least one tab member located along a length thereof.

40. The wheel cover assembly of claim 39, wherein the at least one extension includes a plurality of apertures that snappingly receive the tabs of the fingers of the proximal portion of the at least one connector member therein.

41. The wheel cover assembly of claim 39, wherein the at least one extension includes a plurality of tab members that snappingly couple with the at least one tab member of each of the fingers of the proximal portion of the at least one connector.

42. The wheel cover assembly of claim 33, wherein the proximal portion of the at least one connector member includes a plurality of longitudinally extending flexibly resilient fingers.

43. The wheel cover assembly of claim 42, wherein each of the fingers of the proximal portion of the at least one connector member includes at least one tab member located along a length thereof.

44. The wheel cover assembly of claim 43, wherein the at least one extension includes a plurality of apertures that snappingly receive the tabs of the fingers of the proximal portion of the at least one connector member therein.

45. The wheel cover assembly of claim 43, wherein the at least one extension includes a plurality of tab members that snappingly couple with the at least one tab member of each of the fingers of the proximal portion of the at least one connector.

46. The wheel cover assembly of claim 33, wherein the at least one extension comprises a first material, and wherein the at least one connector member comprises a second material that is different than the first material.

47. The wheel cover assembly of claim 33, wherein the at least one connector member includes a plurality of connector members, and wherein the plurality of connector members are connected to one another via a plurality of structural members.

48. The wheel cover assembly of claim 47, wherein the connector members and the structural members cooperate to form a ring-shape.
